(19) United States
(12) Patent Application Publication
(10) Pub. No.: US 2011/0048393 A1
(43) Pub. Date: Mar. 3, 2011

(54) INTERNAL COMBUSTION ENGINE CONTROL APPARATUS, AND INTERNAL COMBUSTION ENGINE CONTROL METHOD

(75) Inventors: Tatsuhiko AKITA, Okazaki-shi (JP); Kenichi Saito, Nisshin-shi (JP)

(73) Assignee: TOYOTA JIDOSHA KABUSHIKI KAISHA, Toyota-shi (JP)

(21) Appl. No.: 12/856,897

(22) Filed: Aug. 16, 2010

(30) Foreign Application Priority Data
Aug. 26, 2009 (JP) 2009-195776

(51) Int. Cl. F02M 47/00

(52) U.S. Cl. 123/704

(57) ABSTRACT

It is determined whether or not an in-cylinder-injecting fuel injection valve enters an excessive injection state, by comparing a planned demanded in-cylinder injection amount Fdio and a minimum fuel injection amount Fmin. If Fdio<Fmin is determined, the fuel injection from the in-cylinder-injecting fuel injection valve is prohibited, and the fuel injection of the amount that is prohibited is carried out through the in-intake passageway fuel injection performed by the intake port-injecting fuel injection valve. This realizes more accurate amount of fuel injection. Therefore, even during an excessively high pressure state of fuel, for example, at the time of high-temperature dead soak or the like, excessive fuel injection is not performed, so that rich shift of the air/fuel ratio can be restrained. In consequent, deterioration of emissions can be prevented.

### INCORPORATION BY REFERENCE

The disclosure of Japanese Patent Application No. 2009-195776 filed on Aug. 26, 2009 including the specification, drawings and abstract is incorporated herein by reference in its entirety.

### BACKGROUND OF THE INVENTION

1. Field of the Invention

The invention relates to an internal combustion engine control apparatus and an internal combustion engine control method for injecting fuel into a combustion chamber of an internal combustion engine.

2. Description of the Related Art

An internal combustion engine equipped with an in-cylinder fuel injection valve for injecting fuel into a combustion chamber is known. In conjunction with this type of internal combustion engine, there has been proposed an apparatus that restrains the fuel leakage from an in-cylinder fuel injection valve and the production of fuel vapor by reducing the pressure of high-pressure fuel supplied to the in-cylinder fuel injection valve from a high-pressure fuel pump, through the use of a pressure reducing mechanism during a stop of the high-pressure fuel pump (see, e.g., Japanese Patent Application Publication No. 2009-121395 (JP-A-2009-121395), Japanese Patent Application Publication No. 2009-115009 (JP-A-2009-115009), and Japanese Patent Application Publication No. 2009-091963 (JP-A-2009-091963)).

Another known internal combustion engine is equipped with an in-cylinder fuel injection valve for injecting fuel into a combustion chamber and an in-intake passageway fuel injection valve for injecting fuel into an intake passageway. In conjunction with this type of internal combustion engine, an apparatus that sets the proportions of allotment of the two systems of fuel injection according to the state of operation of the internal combustion engine has been proposed (see, e.g., Japanese Patent Application Publication No. 2001-336439 (JP-A-2001-336439), and Japanese Patent Application Publication No. 2006-132336 (JP-A-2006-132336)). In particular, in Japanese Patent Application Publication No. 2001-336439 (JP-A-2001-336439), while the high-pressure fuel system corresponding to the in-cylinder fuel injection valve has low pressure, the in-intake passageway fuel injection valve is used as a main fuel injection valve, and when the pressure of the high-pressure fuel system becomes high, the proportion of allotment of the fuel injection by the in-cylinder fuel injection valve is increased, whereby the starting of the internal combustion engine is made stable and the deterioration of emissions is substantially prevented. In Japanese Patent Application Publication No. 2006-132336 (JP-A-2006-132336), when the fuel injection from the in-intake passageway fuel injection valve abnormally stops, the purge rate is raised to prevent torque fluctuation.

In an internal combustion engine that executes fuel injection into the combustion chambers, that is, so-called in-cylinder injection, the fuel pressure is made high during a state of high load or high rotation speed of the internal combustion engine, and is made low during a state of low load and low rotation speed of the engine.

Hence, in vehicle internal combustion engines and the like, for example, when a driver of the vehicle or the like rapidly releases the accelerator pedal, the fuel pressure supplied to the in-cylinder fuel injection valves needs to be reduced in the same manner. Therefore, in Japanese Patent Application Publication No. 2009-121395 (JP-A-2009-121395), Japanese Patent Application Publication No. 2009-115009 (JP-A-2009-115009) and Japanese Patent Application Publication No. 2009-091963 (JP-A-2009-091963) mentioned above, the apparatuses have such a construction as to reduce the pressure of high-pressure fuel during a low load state of the engine or at the time of a stop of the engine.

However, such a pressure reducing mechanism is provided corresponding to the performance of the high-pressure fuel pump, and the pressure reducing speed of the mechanism is set so that an appropriate fuel pressure is realized in the high-pressure fuel system when the high-pressure fuel pump is driven. Therefore, when the operation of the engine rapidly and greatly changes to the low-load and low-rotation speed side due to the fuel-cut or the like and the high-pressure fuel pump sharply slows down or stops, so that high-pressure fuel discontinues to be supplied, the actual fuel pressure in the high-pressure fuel system cannot follow the rapid change in quick response, but a state of the fuel pressure being excessively higher than a demanded pressure continues.

Therefore, the minimum fuel injection amount of the in-cylinder fuel injection valve does not promptly drop, and therefore restricts the target amount of fuel injection that is reduced according to the decrease of the load. As a result, when the engine resumes combustion, the amount of fuel that is actually injected into the combustion chambers becomes excessively large. This leads to a rich shift of air/fuel ratio, giving rise to possibility of deterioration of emissions.

The technology of Japanese Patent Application Publication No. 2001-336439 (JP-A-2001-336439) controls the transition of the proportions of allotment in fuel injection in an internal combustion engine when the fuel pressure in the high-pressure fuel system gradually rises from a low pressure state at the time of start of the engine. The technology of Japanese Patent Application Publication No. 2006-132336 (JP-A-2006-132336) is a control performed at the time of an abnormal stop of the fuel injection through the in-intake passageway fuel injection valve. Hence, neither of these patent applications is relevant to the rapid drop of load of an engine during operation thereof or to the excessive fuel injection at low engine speeds.

### SUMMARY OF THE INVENTION

The invention provides an internal combustion engine control apparatus and an internal combustion engine control method that restrain the air/fuel ratio of an internal combustion engine from becoming rich when the fuel pressure in the high-pressure fuel system is excessively high with respect to the state of operation of the engine while the engine is executing the in-cylinder injection.

An internal combustion engine control apparatus in accordance with a first aspect of the invention is a control apparatus for an internal combustion engine that includes: in-cylinder fuel injection means for injecting fuel into a combustion chamber of an internal combustion engine; and in-intake passageway fuel injection means for injecting fuel into an intake passageway of the internal combustion engine. The internal combustion engine control apparatus includes: excessive injection state determination means for determining whether or not an excessive injection state in which actual amount of fuel injection by the in-cylinder fuel injection means is greater than a demanded in-cylinder fuel injection amount for the in-cylinder fuel injection means occurs; and alternative injection means for prohibiting fuel injection performed by the in-cylinder fuel injection means and executing the fuel injection of the demanded in-cylinder fuel injection amount by in-intake passageway fuel injection performed by the in-intake passageway fuel injection means, if it is determined by the excessive injection state determination means that the excessive injection state occurs.

If it is determined by the excessive injection state determination means that the excessive injection state in which the actual amount of fuel injection by the in-cylinder fuel injection means is greater than the demanded in-cylinder fuel injection amount occurs, the alternative injection means prohibits the fuel injection performed by the in-cylinder fuel injection means, and causes the fuel injection of the demanded in-cylinder fuel injection amount to be carried out by the in-intake passageway fuel injection performed by the in-intake passageway fuel injection means.

Due to this construction, even in a situation of operation of the internal combustion engine in which the fuel pressure in a high-pressure fuel system is excessively high, the fuel injection of the demanded in-cylinder fuel injection amount into the intake passageway is accomplished by the in-intake passageway fuel injection means performed by a low-pressure fuel system. Since the in-intake passageway fuel injection means is constructed so as to have low pressure of fuel, the minimum fuel injection amount of the in-intake passageway fuel injection means is sufficiently small, so that the fuel injection of the demanded in-cylinder fuel injection amount can sufficiently be carried out, and accurate amount of fuel can be injected. In particular, the in-intake passageway fuel injection means is also constructed so as to have an allotted amount of fuel. Therefore, this allotted amount of fuel and the demanded in-cylinder fuel injection amount combined result in an increase in the demanded amount of injection of the in-intake passageway fuel injection means, so that the minimum fuel injection amount of the in-intake passageway fuel injection means is not a problem.

Due to this, in an internal combustion engine that is executing in-cylinder injection, the rich shift of air/fuel ratio can be restrained in the case where the fuel pressure in the high-pressure fuel system is excessively high for the state of operation of the internal combustion engine.

Besides, the excessive injection state determination means may handle as a kind of the excessive injection state a state in which a minimum fuel injection amount of the in-cylinder fuel injection means is greater than the demanded in-cylinder fuel injection amount for the in-cylinder fuel injection means, or a state that occurs immediately before the minimum fuel injection amount becomes greater than the demanded in-cylinder fuel injection amount.

During a state in which the minimum fuel injection amount of the in-cylinder fuel injection means is greater than the demanded in-cylinder fuel injection amount, the fuel injection performed by the in-cylinder fuel injection means will shift the air/fuel ratio to the rich side. Therefore, if the excessive injection state determination means handles as a kind of the excessive injection state a state in which the minimum fuel injection amount is greater than the demanded in-cylinder fuel injection amount, or a state that occurs immediately before the minimum fuel injection amount becomes greater than the demanded in-cylinder fuel injection amount, it is possible to restrain the rich shift of air/fuel ratio through the process performed by the alternative injection means.

Besides, the excessive injection state determination means may set a reference pressure that has possibility of causing the excessive injection state in the in-cylinder fuel injection means, and the excessive injection state determination means may handle as a kind of the excessive injection state a state in which fuel pressure supplied to the in-cylinder fuel injection means is greater than the reference pressure, or a state that occurs immediately before the fuel pressure becomes greater the reference pressure.

The foregoing comparison between the minimum fuel injection amount and the demanded in-cylinder fuel injection amount may be omitted, and a reference pressure as mentioned above may be set for the fuel pressure, and a state in which the fuel pressure supplied to the in-cylinder fuel injection means is greater than the reference pressure, or a state that occurs immediately before the fuel pressure supplied thereto becomes greater than the reference pressure may be determined as a kind of the excessive injection state.

Due to this, too, the process by the alternative injection means can be appropriately executed to restrain the rich shift of air/fuel ratio.

Besides, the internal combustion engine control apparatus may further include fuel injection amount allotment setting means for setting allotments of fuel injection amount to the in-cylinder fuel injection means and to the in-intake passageway fuel injection means according to state of operation of the internal combustion engine, and if it is determined by the excessive injection state determination means that the excessive injection state occurs, the alternative injection means may cause the fuel injection amount allotment setting means to set the fuel injection amount allotments so that no fuel injection amount is allotted to the in-cylinder fuel injection means and entire fuel injection amount is accomplished by the in-intake passageway fuel injection means.

Thus, in the case where the allotment of the fuel injection amount to the in-cylinder fuel injection means and to the in-intake passageway fuel injection means is carried out according to the state of operation of the internal combustion engine, the alternative injection means is able to restrain the rich shift of air/fuel ratio during the excessive injection state by eliminating the allotment of fuel injection amount to the in-cylinder fuel injection means and allotting the entire fuel injection amount to the in-intake passageway fuel injection means.

Besides, the internal combustion engine control apparatus may further include in-cylinder injection fuel pressure adjustment means for adjusting fuel pressure supplied to the in-cylinder fuel injection means according to state of operation of the internal combustion engine.

In the case where the state of operation of the internal combustion engine rapidly changes and, particularly, where the state of operation of the internal combustion engine has such a change that the fuel pressure adjusted by the in-cylinder injection fuel pressure adjustment means needs to be rapidly reduced, if the excessive injection state determination means determines that the excessive injection state occurs as described above, the alternative injection means functions as described above, so that the rich shift of air/fuel ratio can be restrained.

Besides, the in-cylinder injection fuel pressure adjustment means may adjust pressure of fuel supplied to the in-cylinder fuel injection means according to the state of operation of the internal combustion engine by controlling driving of a fuel pressure boost mechanism that boosts pressure of fuel whose pressure has been brought to a fuel pressure that is used for injection performed by the in-intake passageway fuel injection means, and that supplies pressure-boosted fuel to the in-cylinder fuel injection means.

The fuel pressure supplied to the in-cylinder fuel injection means may also be set as described above. If it is determined by the excessive injection state determination means that the fuel pressure is in such a state as to cause an excessive injection state as described above, the rich shift of air/fuel ratio can be restrained by a function of the alternative injection means.

Besides, the fuel pressure boost mechanism may include pressure reduction means for reducing the fuel pressure at in-cylinder fuel injection means side when a pressure boosting process performed by the fuel pressure boost mechanism is stopped.

In the case where the fuel pressure boost mechanism includes the pressure reduction means in the foregoing manner, too, if the state of operation of the internal combustion engine rapidly changes so that it is impossible to perform sufficiently rapid pressure reduction by the pressure reduction means, the excessive injection state results. However, in this case, too, the rich shift of air/fuel ratio can be restrained by the function of the alternative injection means.

An internal combustion engine control apparatus in accordance with a second aspect of the invention is a control apparatus for an internal combustion engine that includes: in-cylinder fuel injection means for injecting fuel into a combustion chamber of an internal combustion engine; and in-intake gas introduction means for introducing a component that affects air/fuel ratio into an intake passageway of the internal combustion engine. The internal combustion engine control apparatus includes: excessive injection state determination means for determining whether or not an excessive injection state in which actual amount of fuel injection by the in-cylinder fuel injection means is greater than a demanded in-cylinder fuel injection amount for the in-cylinder fuel injection means occurs; and rich-shift restraint means for adjusting amount of the component introduced by the in-intake gas introduction means to such a side that the air/fuel ratio increases, if it is determined by the excessive injection state determination means that the excessive injection state occurs.

In the case where it is determined by the excessive injection state determination means that the excessive injection state in which the actual amount of fuel injection by the in-cylinder fuel injection means is greater than the demanded in-cylinder fuel injection amount occurs, the rich-shift restraint means adjusts the amount of the component introduced by the in-intake gas introduction means to such a side that the air/fuel ratio increases.

Therefore, even if the amount of fuel actually injected from the in-cylinder fuel injection means becomes excessive, the amount of the component introduced into the intake passageway by the in-intake gas introduction means is adjusted to such a side that the air/fuel ratio increases, that is, to the lean side. Therefore, in an internal combustion engine that is executing in-cylinder injection, the rich shift of air/fuel ratio can be restrained also in the case where the fuel pressure in the high-pressure fuel system is excessively high for the state of operation of the internal combustion engine.

Therefore, a demanded in-cylinder injection is not cancelled, and therefore the opportunities of executing the in-cylinder injection can be increased, so that smooth internal combustion engine control becomes possible.

Besides, the in-intake gas introduction means may include purge means for introducing fuel vapor from a canister into the intake passageway, and the rich-shift restraint means may execute adjustment to such a side as to increase the air/fuel ratio, by lessening amount of the fuel vapor introduced by the purge means.

In the case where the component introduced into the intake passageway is fuel vapor introduced from the canister by the purge means, the rich-shift restraint means, by lessening the amount of fuel vapor introduced, is able to restrain the rich shift of the air/fuel ratio even when the fuel pressure in the high-pressure fuel system is excessively high for the state of operation of the internal combustion engine.

Besides, the in-intake gas introduction means may include blowby gas reduction means for introducing blowby gas into the intake passageway, and the rich-shift restraint means may execute adjustment to such a side as to increase the air/fuel ratio, by adjusting amount of the blowby gas introduced by the blowby gas reduction means.

In the case where the component introduced into the intake passageway is blowby gas introduced by the blowby gas reduction means, the rich-shift restraint means, by adjusting the amount of blowby gas introduced, is able to restrain the rich shift of the air/fuel ratio even when the fuel pressure in the high-pressure fuel system is excessively high for the state of operation of the internal combustion engine.

Besides, the in-intake gas introduction means may include exhaust gas recirculation means that recirculates exhaust gas into the intake passageway, and the rich-shift restraint means may execute adjustment to such a side as to increase the air/fuel ratio, by lessening amount of the exhaust gas recirculated by the exhaust gas recirculation means.

In the case where the component introduced into the intake passageway is exhaust gas recirculated by the exhaust gas recirculation means, the rich-shift restraint means, by lessening the amount of the exhaust gas recirculation, is able to restrain the rich shift of the air/fuel ratio even when the fuel pressure in the high-pressure fuel system is excessively high for the state of operation of the internal combustion engine.

Besides, the internal combustion engine control apparatus may further include in-intake passageway fuel injection means for injecting fuel into the intake passageway of the internal combustion engine, besides the in-cylinder fuel injection means.

Besides, the internal combustion engine control apparatus may further include fuel injection amount allotment setting means for setting allotments of fuel injection amount to the in-cylinder fuel injection means and to the in-intake passageway fuel injection means according to state of operation of the internal combustion engine.

In the construction that includes the in-intake passageway fuel injection means besides the in-cylinder fuel injection means, the allotments of fuel injection amount to the in-intake passageway fuel injection means and to the in-cylinder fuel injection means may be set according to the state of operation of the internal combustion engine.

Besides, the internal combustion engine control apparatus may further include in-cylinder injection fuel pressure adjustment means for adjusting fuel pressure supplied to the in-cylinder fuel injection means according to state of operation of the internal combustion engine.

In the case where the state of operation of the internal combustion engine rapidly changes and, particularly, where the state of operation of the internal combustion engine has such a change that the fuel pressure adjusted by the in-cylinder injection fuel pressure adjustment means needs to be rapidly reduced, if the excessive injection state determination means determines that the excessive injection state occurs as described above, the rich-shift restraint means functions as described above, so that the rich shift of air/fuel ratio can be restrained.

Besides, the in-cylinder injection fuel pressure adjustment means may adjust pressure of fuel supplied to the in-cylinder fuel injection means according to the state of operation of the internal combustion engine by controlling driving of a fuel pressure boost mechanism that boosts pressure of fuel whose pressure has been brought to a fuel pressure that is used for injection by the in-intake passageway fuel injection means, and that supplies pressure-boosted fuel to the in-cylinder fuel injection means.

The fuel pressure supplied to the in-cylinder fuel injection means may be set in this manner. In the case where it is determined by the excessive injection state determination means that the fuel pressure is in such a state as to cause the excessive injection state as described above, the rich-shift of air/fuel ratio can be restrained by the function of the rich-shift restraint means.

Besides, the fuel pressure boost mechanism may include pressure reduction means for reducing the fuel pressure at an in-cylinder fuel injection means side when a pressure boosting process performed by the fuel pressure boost mechanism is stopped.

In the case where the fuel pressure boost mechanism includes the pressure reduction means in the foregoing manner, too, if the state of operation of the internal combustion engine rapidly changes so that it is impossible to perform sufficiently rapid pressure reduction by the pressure reduction means, the excessive injection state results. However, in this case, too, the rich shift of air/fuel ratio can be restrained by the function of the rich-shift restraint means.

An internal combustion engine control method in accordance with a third aspect of the invention is a control method for an internal combustion engine that includes: in-cylinder fuel injection means for injecting fuel into a combustion chamber of the internal combustion engine; and in-intake passageway fuel injection means for injecting fuel into an intake passageway of the internal combustion engine. The control method includes:

determining whether or not an excessive injection state in which actual amount of fuel injection by the in-cylinder fuel injection means is greater than a demanded in-cylinder fuel injection amount for the in-cylinder fuel injection means occurs; and

prohibiting fuel injection performed by the in-cylinder fuel injection means and executing the fuel injection of the demanded in-cylinder fuel injection amount through in-intake passageway fuel injection performed by the in-intake passageway fuel injection means, if it is determined that the excessive injection state occurs.

An internal combustion engine control method in accordance with a fourth aspect of the invention is a control method for an internal combustion engine that includes: in-cylinder fuel injection means for injecting fuel into a combustion chamber of the internal combustion engine; and in-intake gas introduction means for introducing a component that affects air/fuel ratio into an intake passageway of the internal combustion engine. The control method includes:

determining whether or not an excessive injection state in which actual amount of fuel injection by the in-cylinder fuel injection means is greater than a demanded in-cylinder fuel injection amount for the in-cylinder fuel injection means occurs; and

adjusting amount of the component introduced by the in-intake gas introduction means to such a side that the air/fuel ratio increases, if it is determined that the excessive injection state occurs.

According to the internal combustion engine control methods in accordance with the third and fourth aspects of the invention, the rich shift of air/fuel ratio can be restrained in an internal combustion engine that is executing in-cylinder injection, in the case where the fuel pressure in the high-pressure fuel system is excessively high for the state of operation of the internal combustion engine.

### BRIEF DESCRIPTION OF THE DRAWINGS

The foregoing and further features and advantages of the invention will become apparent from the following description of example embodiments with reference to the accompanying drawings, wherein like numerals are used to represent like elements, and wherein:

FIG. 1 is a block diagram representing a general construction of an internal combustion engine and a control apparatus thereof in accordance with Embodiment 1;

FIG. 2 is an illustrative diagram of a construction of a fuel injection system of the internal combustion engine in Embodiment 1;

FIG. 3 is an illustrative diagram of a construction of a map MAPpf for calculating a high-pressure fuel pressure Pf on the basis of the load factor KL and engine rotation speed NE in Embodiment 1;

FIG. 4 is a flowchart of a fuel injection allotment control process that an ECU executes in Embodiment 1;

FIG. 5 is an illustrative diagram of a construction of a map MAPfmin calculating a minimum fuel injection amount Fmin on the basis of the high-pressure fuel pressure Pf in the fuel injection allotment control process in Embodiment 1;

FIG. 6 is an illustrative diagram of a construction of a map MAPrf for calculating an in-cylinder injection allotment proportion Rf on the basis of the load factor KL and the engine rotation speed NE in the fuel injection allotment control process in Embodiment 1;

FIG. 7 is a timing chart showing transition of decrease of the high-pressure fuel pressure Pf in the case where fuel-cut is executed in the fuel injection system in Embodiment 1 during a high load state of the engine;

FIG. 8 is a flowchart of a fuel injection allotment control process in accordance with Embodiment 3;

FIG. 9 is a block diagram representing a general construction of an internal combustion engine and a control apparatus thereof in accordance with Embodiment 5;

FIG. 10 is a flowchart of a fuel injection allotment control process in Embodiment 5;

FIG. 11 is a flowchart of a fuel injection allotment control process in Embodiment 6;

FIG. 12 is a block diagram representing a general construction of an internal combustion engine and a control apparatus thereof in Embodiment 7; and

FIG. 13 is a flowchart of a fuel injection control process that an ECU executes in Embodiment 7.

### DETAILED DESCRIPTION OF EMBODIMENTS

### Embodiment 1

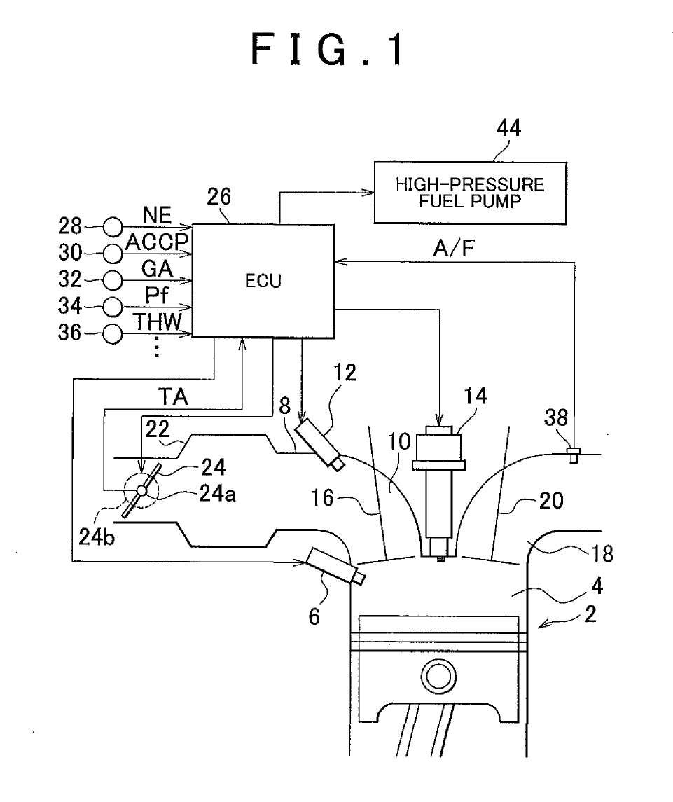

FIG. 1 is a block diagram representing a general construction of an internal combustion engine 2 and an internal combustion engine control apparatus to which the invention is applied. The internal combustion engine 2 is an internal combustion engine for a vehicle. This engine 2 is provided with in-cylinder-injecting fuel injection valves 6 (corresponding to in-cylinder fuel injection means) that inject fuel into combustion chambers 4. An intake passageway 8 of the engine 2 is provided with intake port-injecting fuel injection valves 12 (corresponding to in-intake passageway fuel injection means) that inject fuel into intake gas in intake ports 10. Thus, the internal combustion engine 2 of this embodiment adopts a dual injection system. An ignition plug 14 that ignites by spark a mixture of fuel and air is provided on a top surface of each combustion chamber 4 of the internal combustion engine 2.

The combustion chambers 4 are provided with intake valves 16 that open and close the intake ports 10, and exhaust valves 20 that open and close exhaust ports 18. In the intake passageway 8, a surge tank 22 is provided at an upstream side of the intake port 10, and a throttle valve 24 that adjusts the amount of air taken into all the cylinders of the internal combustion engine 2 is provided at an upstream side of the surge tank 2. The degree of opening of the throttle valve 24 (degree of throttle opening TA) is detected by a throttle opening degree sensor 24a. The detection signal of the sensor 24a is input to an electronic control unit (hereinafter, referred to as “ECU”) 26.

The ECU 26 is an electronic control circuit having a microcomputer as a central component, and is equipped with an input/output circuit, and executes an internal combustion engine control. Besides the throttle opening degree signal, other signals are also input to the ECU 26, including a signal representing the engine rotation speed NE that is sent from an internal combustion engine rotation speed sensor 28, a signal representing the amount of accelerator operation ACCP that is sent from an accelerator operation amount sensor 30 that detects the amount of depression of an accelerator pedal; and a signal representing the intake gas amount GA that is sent from an air flow meter 32 disposed in the intake passageway 8 at an upstream side of the throttle valve 24. The ECU 26 further inputs a signal representing the fuel pressure Pf of high-pressure fuel from a fuel pressure sensor 34 that is provided in a high-pressure fuel system for the purpose of the fuel injection control performed by the in-cylinder-injecting fuel injection valves 6, a signal representing the cooling water temperature THW from a cooling water temperature sensor 36 of the internal combustion engine 2, a signal representing the air/fuel ratio A/F from an air/fuel ratio sensor 38 provided in the exhaust system, and other signals.

On the basis of various signal data input, the ECU 26 controls the internal combustion engine 2 using programs and map data pre-stored in an internal memory. Specifically, the valve opening timing and the length of the open duration of the two types of fuel injection valves 6 and 12 are adjusted in order to supply appropriate amount of fuel at an appropriate timing corresponding to the state of operation of the internal combustion engine during an air intake operation. Furthermore, in order to adjust the engine output, the degree of throttle opening TA is adjusted by driving an electric motor 24b that rotates the shaft of the throttle valve 24, and the ignition timing of the ignition plugs 14 is adjusted.

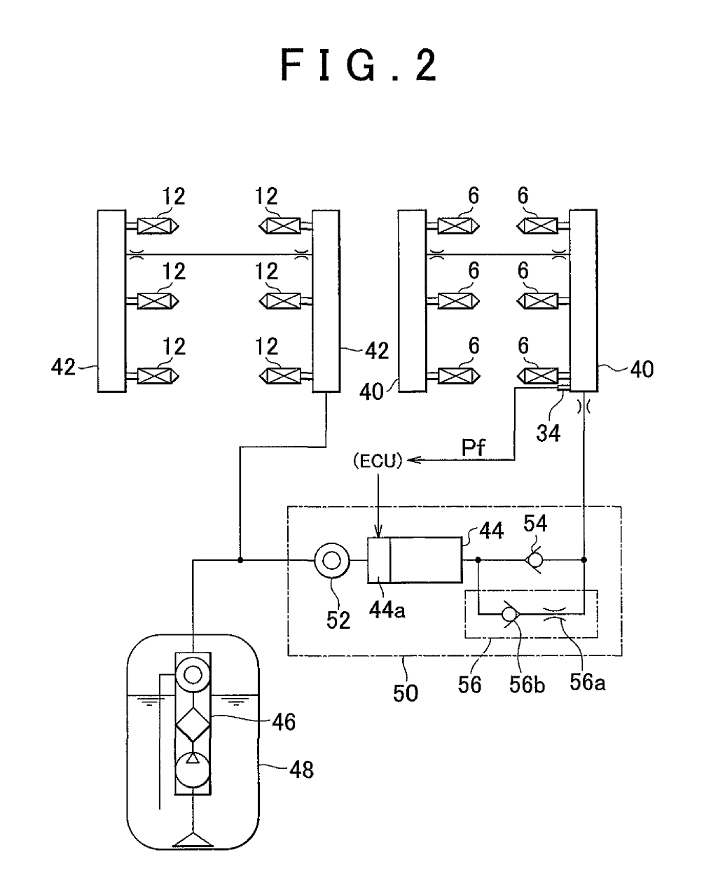

FIG. 2 shows a construction of the fuel injection system. It is to be noted herein that the internal combustion engine 2 is a V-type six-cylinder engine, and has six in-cylinder-injecting fuel injection valves 6 and six intake port-injecting fuel injection valves 12 as a whole, that is, three of each type of injection valve on each of the left and right banks

The in-cylinder-injecting fuel injection valves 6 are supplied with high-pressure fuel from high-pressure fuel distribution pipes 40, and the intake port-injecting fuel injection valves 12 are supplied with low-pressure fuel from low-pressure fuel distribution pipes 42. The supply of fuel to the high-pressure fuel distribution pipes 40 is carried out by a high-pressure fuel pump 44, and the supply of fuel to the low-pressure fuel distribution pipes 42 is carried out by a fuel feed pump 46 that is a low-pressure pump. The fuel feed pump 46 sucks fuel from the fuel tank 48, and discharges fuel at a constant fuel pressure to the low-pressure fuel distribution pipe 42 side. A portion of the fuel thus discharged is supplied to a fuel pressure boost mechanism 50 that includes the high-pressure fuel pump 44.

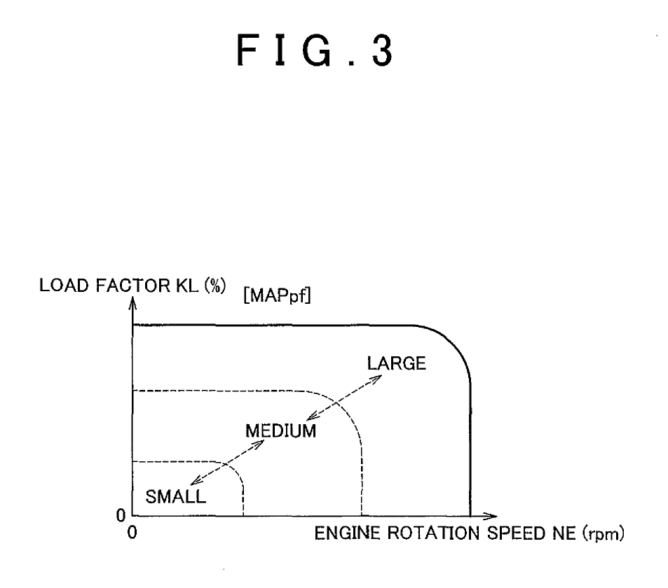

The high-pressure fuel pump 44 is driven by the internal combustion engine 2, for example, reciprocates a plunger within a cylinder due to rotation of the intake camshaft. A pressurization chamber defined by the cylinder and the plunger has a fuel introduction opening which is provided with an electromagnetic open-close valve 44a. Low-pressure fuel metered through the open-close control of the electromagnetic open-close valve 44a by the ECU 26 is raised in pressure in the pressurization chamber, and is discharged as high-pressure fuel to the high-pressure fuel distribution pipe 40 from a discharge opening provided for the pressurization chamber. In this embodiment, the discharge amount of the high-pressure fuel pump 44 is adjusted so that the fuel pressure Pf of the high-pressure fuel distribution pipe 40 detected by the fuel pressure sensor 34 becomes equal to a pressure commensurate with the state of operation of the internal combustion engine. Concretely, using a map MAPpf as shown in FIG. 3, a fuel pressure Pf is calculated on the basis of the load factor KL and the engine rotation speed NE, in order to adjust the discharge force. It is to be noted herein that the load factor KL is an index that represents the internal combustion engine load, and is a proportion (%) of the intake gas amount GA/NE for one actual rotation of the internal combustion engine 2 to a reference maximum intake gas amount for one rotation thereof. This load used herein may be the measured intake pressure in the surge tank 22 as well as the load factor KL.

Incidentally, in the fuel pressure boost mechanism 50, a pulsation dumper 52 is disposed at the suction side of the high-pressure fuel pump 44, so as to prevent the effect of pulsation to the low pressure side. A discharge side of the high-pressure fuel pump 44 is provided with a discharge valve 54 for blocking reverse flow and allowing high-pressure fuel to flow to the high-pressure fuel distribution pipe 40 side. In parallel with the discharge valve 54, a pressure reducing mechanism 56 (corresponding to pressure reduction means) is provided.

The pressure reducing mechanism 56 is made up by connecting an orifice 56a and a check valve 56b in series, and does not impede the fuel pressure adjustment of high-pressure fuel pressure in the high-pressure fuel distribution pipe 40 which is performed by the high-pressure fuel pump 44 being electromagnetically driven to discharge fuel to the high-pressure fuel distribution pipe 40. However, when the discharge from the high-pressure fuel pump 44 is stopped, the pressure reducing mechanism 56 reduces the pressure of the high-pressure fuel in the high-pressure fuel distribution pipe 40 to a demanded pressure; that is, the flow resistance by the orifice 56a and the opening pressure of the check valve 56b are set so as to perform the foregoing operation. This prevents fuel leaking from an in-cylinder-injecting fuel injection valve 6 at the time of stop of the internal combustion engine 2, and improves emissions the next time the internal combustion engine 2 is started. Incidentally, the check valve 56b also serves the purpose of restraining the generation of vapor of fuel in the high-pressure fuel distribution pipe 40 side during a high-temperature dead soak.

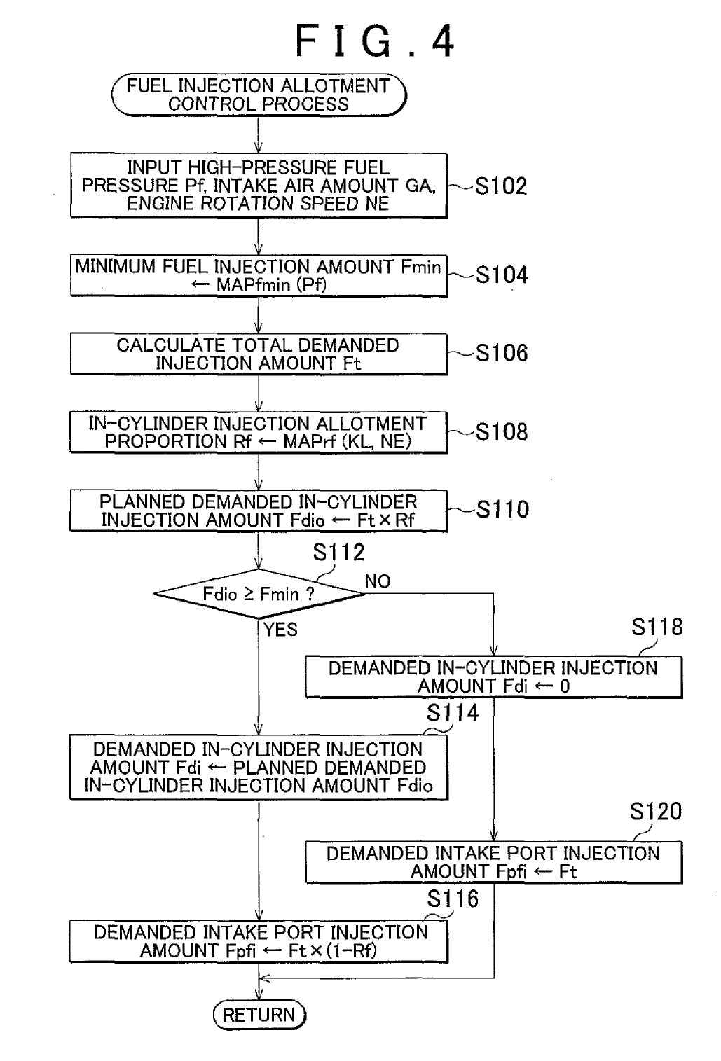

Among the controls executed by the ECU 26, a fuel injection allotment control process is shown by a flowchart in FIG. 4. This process is executed by interrupt at every rotation of a constant crank angle. Incidentally, steps in the flowchart that correspond to individual process contents are expressed with “S”.

When this process starts, firstly, the high-pressure fuel pressure Pf detected by the fuel pressure sensor 34, the intake gas amount GA detected by the air flow meter 32, and the engine rotation speed NE detected by the internal combustion engine rotation speed sensor 28 are input into a working area of the memory of the ECU 26 (S102).

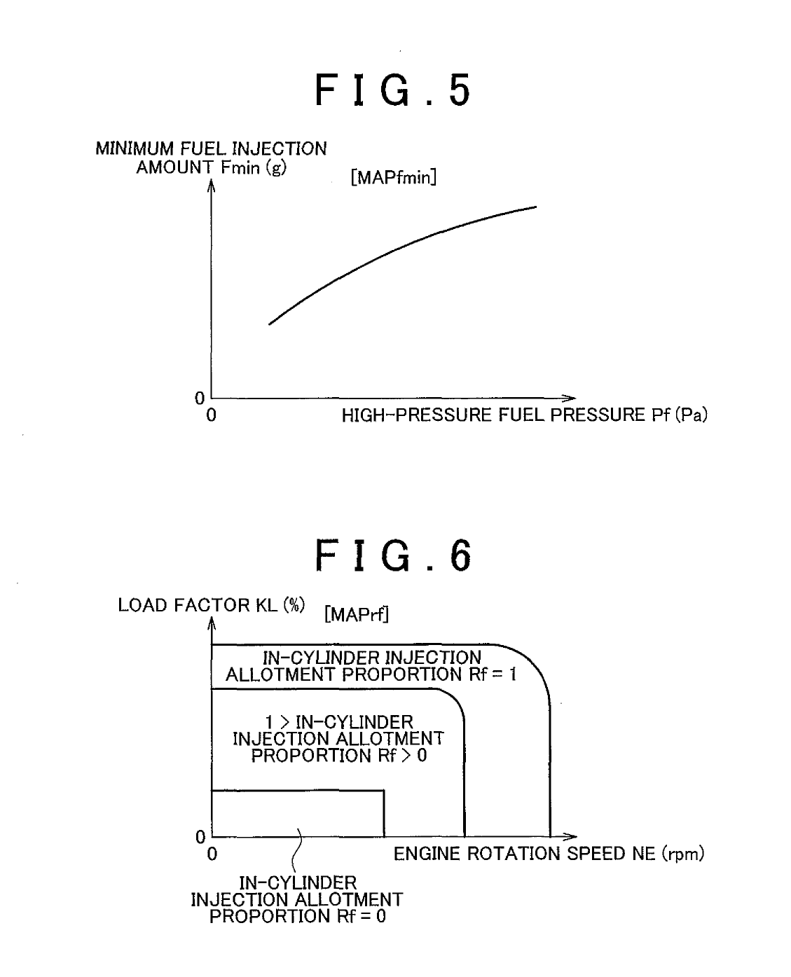

Next, using the map MAPfmin shown in FIG. 5, a minimum fuel injection amount Fmin (an amount by one action of injection, in the unit of gram) is calculated on the basis of the high-pressure fuel pressure Pf (Pa) (S104). This map MAPfmin is prepared beforehand by performing mapping on the basis of the values of the minimum fuel injection amount Fmin that are actually measured while the fuel pressure supplied to the same kind of in-cylinder-injecting fuel injection valve 6 as that used in this internal combustion engine 2 is changed. This minimum fuel injection amount Fmin is a limit amount of fuel below which it is impossible to carry out fuel injection. As can be seen in FIG. 5, the higher the high-pressure fuel pressure Pf, the larger the minimum fuel injection amount Fmin. That is, FIG. 5 shows that the higher the high-pressure fuel pressure Pf, the higher the lower-limit value of the amount of fuel that the in-cylinder-injecting fuel injection valve 6 can inject as demanded, and that the higher the high-pressure fuel pressure Pf, the more expanded the region in which injection of small amounts of fuel is impossible.

Next, a total demanded injection amount Ft (an amount by one combustion stroke, in the unit of gram) that is an amount of fuel injection that is needed for the present state of operation of the internal combustion engine is calculated by an air/fuel ratio feedback control process using data of the intake gas amount GA, the engine rotation speed NE and the air/fuel ratio A/F (S106). This total demanded injection amount Ft may also be obtained by inputting a total demanded injection amount that has already been calculated by another process.

Next, using the map MAPrf shown in FIG. 6, an in-cylinder injection allotment proportion Rf is calculated on the basis of the load factor KL and the engine rotation speed NE (S108). In this map MAPrf, the in-cylinder injection allotment proportion Rf is mapped beforehand by setting the proportion of allotment for executing the fuel injection through combination of the in-cylinder injection performed by the in-cylinder-injecting fuel injection valves 6 and the port injection performed by the intake port-injecting fuel injection valves 12 for the purpose of improvement of the fuel economy characteristic and the output characteristic according to the state of operation of the internal combustion engine.

As shown in FIG. 6, during a state of high load (large load factor KL) or high rotation speed (high engine rotation speed NE), the in-cylinder injection allotment proportion Rf=1, that is, the fuel injection is entirely performed by the in-cylinder-injecting fuel injection valves 6. Therefore, the fuel injection from the intake port-injecting fuel injection valves 12 is not performed.

During a state of low load (small load factor KL) and low rotation speed (low engine rotation speed NE), the in-cylinder injection allotment proportion Rf=0, that is, the fuel injection is entirely performed by the intake port-injecting fuel injection valves 12. Therefore, the fuel injection from the in-cylinder-injecting fuel injection valves 6 is not performed.

Therefore, in the intermediate region between the foregoing two states, both the in-cylinder-injecting fuel injection valves 6 and the intake port-injecting fuel injection valves 12 are used in a combined use. Concretely, as the state of operation of the engine becomes closer to the region of low load and low rotation speed, the in-cylinder injection allotment portion Rf becomes closer to zero, so that the allotted injection amount of the in-cylinder-injecting fuel injection valves 6 decreases, and the allotted injection amount of the intake port-injecting fuel injection valves 12 increases. On the other hand, as the state of operation of the engine becomes closer to the region of high load or high rotation speed, the in-cylinder injection allotment portion Rf becomes closer to “1”, so that the allotted injection amount of the in-cylinder-injecting fuel injection valves 6 increases, and the allotted injection amount of the intake port-injecting fuel injection valves 12 decreases.

Next, using the expression 1, a planned demanded in-cylinder injection amount Fdio (an amount per injection in the unit of gram) is calculated (S110).

Fdio←Ft×Rf (expression 1)

That is, in the case where the allotment as shown in FIG. 6 is carried out, the amount of fuel that is demanded to be injected from the in-cylinder-injecting fuel injection valves 6 (the planned demanded in-cylinder injection amount Fdio) is calculated.

Next, it is determined whether or not the planned demanded in-cylinder injection amount Fdio is greater than or equal to the minimum fuel injection amount Fmin found in step S104 (S112). Herein, if the planned demanded in-cylinder injection amount Fio≧the minimum fuel injection amount Fmin (YES in S112), it means that the fuel injection of the planned demanded in-cylinder injection amount Fdio can be carried out by the in-cylinder-injecting fuel injection valves 6, and therefore the planned demanded in-cylinder injection amount Fdio is directly set as the demanded in-cylinder injection amount Fdi (S114).

Then, as in expression 2, a demanded intake port injection amount Fpfi is calculated (S116).

Fpfi←Ft×(1−Rf) (expression 2)

In this manner, the allotted injection amounts (Fdi, Fpfi) of the fuel injection performed by the in-cylinder-injecting fuel injection valves 6 and of the fuel injection performed by the intake port-injecting fuel injection valves 12 are determined. Therefore, by a fuel injection process separately executed by the ECU 26, the demanded intake port injection amount Fpfi of fuel is injected from the intake port-injecting fuel injection valves 12 at a port injection timing, and the demanded in-cylinder injection amount Fdi of fuel is injected from the in-cylinder-injecting fuel injection valves 6 at an in-cylinder injection timing.

It is assumed that a driver who is driving the vehicle rapidly releases the accelerator pedal rapidly, and therefore the degree of throttle opening TA sharply decreases, so that a fuel-cut process is performed, whereby a high-temperature dead soak state is caused. At this time, since the fuel injection completely stops, the discharge of high-pressure fuel from the high-pressure fuel pump 44 is stopped. Therefore, the high-pressure fuel pressure Pf in the high-pressure fuel distribution pipe 40 is reduced by the pressure reducing mechanism 56. However, this pressure reduction by the pressure reducing mechanism 56 is designed not to be rapid, in order to avoid affecting the fuel pressure of the high-pressure fuel distribution pipe 40 caused by the high-pressure fuel pump 44 during normal state as stated above.

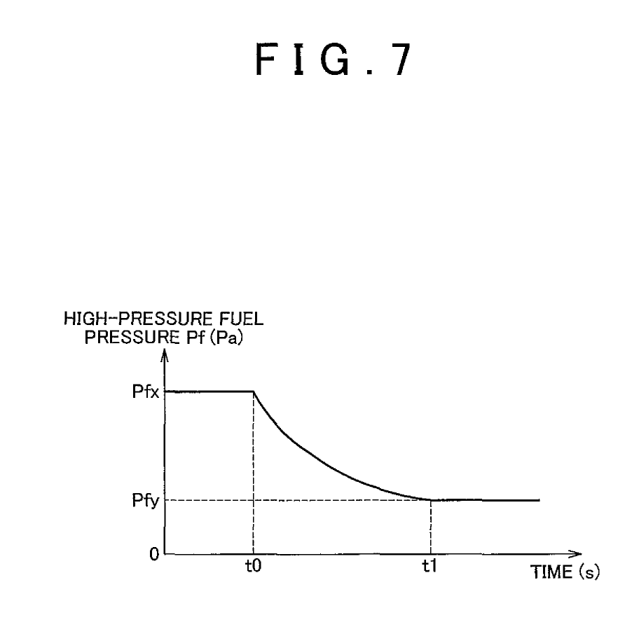

Therefore, as shown in the timing chart of FIG. 7, a certain amount of time (t0 to t1, e.g., several seconds) is needed for the high-pressure fuel pressure Pf to decrease from a high fuel pressure Pfx that corresponds to the high load or the high rotation speed at a fuel-cut timing (t0) to a low fuel pressure Pfy that corresponds to the low load and the low rotation speed (which corresponds to time t1).

Therefore, in the case where the fuel-cut discontinues while the high-pressure fuel pressure Pf has not become sufficiently low, there is possibility of the demanded in-cylinder injection amount Fdi being smaller than the minimum fuel injection amount Fmin. Therefore, in the case where, at the time of discontinuation of the fuel-cut, the planned demanded in-cylinder injection amount Fdio<the minimum fuel injection amount Fmin (No in S112), the demanded in-cylinder injection amount Fdi is set at 0 (S118), and the total demanded injection amount Ft is set as the demanded intake port injection amount Fpfi (S120). That is, the in-cylinder injection allotment proportion Rf=0 is forced to be set.

As for the correspondence of foregoing constructions to elements or the like described in the appended claims, the ECU 26 may be regarded as corresponding to excessive injection state determination means, alternative injection means, fuel injection amount allotment setting means, and in-cylinder injection fuel pressure adjustment means. Furthermore, steps S104, S110 and S112 in the fuel injection allotment control process (FIG. 4) may be regarded as corresponding to a process as the excessive injection state determination means, and steps S118 and S120 may be regarded as corresponding to a process as the alternative injection means, and step S108 may be regarded as corresponding to a process as the fuel injection amount allotment setting means. The control of adjusting the amount of discharge of the high-pressure fuel pump 44 through the open-close control of the electromagnetic open-close valve 44a of the high-pressure fuel pump 44 so that the high-pressure fuel pressure Pf reaches a pressure commensurate with the state of operation of the internal combustion engine may be regarded as corresponding to a process as the in-cylinder injection fuel pressure adjustment means.

According to Embodiment 1 described above, the following effects can be attained. (1) Whether or not an excessive injection state in which the amount of fuel injected from the in-cylinder-injecting fuel injection valves 6 is greater than the demanded in-cylinder fuel injection amount (i.e., the planned demanded in-cylinder injection amount Fdio herein) occurs is determined by comparing the planned demanded in-cylinder injection amount Fdio and the minimum fuel injection amount Fmin (S112). Then, if it is determined that Fdio<Fmin (No in S112), the fuel injection from the in-cylinder-injecting fuel injection valves 6 is prohibited (S118), and the fuel injection of the demanded in-cylinder fuel injection amount (i.e., the planned demanded in-cylinder injection amount Fdio) is carried out by the in-intake passageway fuel injection performed by the intake port-injecting fuel injection valves 12 (S120).

Due to this, in the situation of operation of the internal combustion engine in which the fuel pressure Pf of the high-pressure fuel system is excessively high, the intake port-injecting fuel injection valves 12 in the low-pressure fuel system achieve the additional fuel injection of the planned demanded in-cylinder injection amount Fdio in the intake ports 10. Since the intake port-injecting fuel injection valves 12 are designed so that the fuel pressure is low, the minimum fuel injection amount herein is sufficiently small, and therefore the intake port-injecting fuel injection valves 12 are sufficiently able to carry out the fuel injection of the planned demanded in-cylinder injection amount Fdio. In particular, to the planned demanded in-cylinder injection amount Fdio, the amount Ft(1−Rf) of fuel that is injected at low pressure is added. Therefore, there occurs no particular problem, and accurate amount of fuel injection can be realized.

Despite the provision of the pressure reducing mechanism 56, since the pressure reduction by the pressure reducing mechanism 56 is not very fast as mentioned above, it sometimes occurs that in the fuel injection during the high-temperature dead soak, for example, at the time of discontinuation of the fuel-cut, or the like, the fuel pressure in the high-pressure fuel system is excessively high for the state of operation of the internal combustion engine. In such a case, excessive fuel injection is not performed, as stated above. Therefore, a rich shift of the air/fuel ratio can be restrained, so that deterioration of emissions can be prevented.

### Embodiment 2

In Embodiment 1 it is determined whether or not Fdio≧Fmin in step S112 in the fuel injection allotment control process (FIG. 4), whereas in Embodiment 2 it is determined whether or not Fdio≧Fmin×Kf, or whether or not Fdio≧min+dF.

Herein, the coefficient Kf is a value as an increasing coefficient above 1; for example, the coefficient Kf is “1.1” or the like. The additional value dF represents a value for giving an increase corresponding to a marginal amount to the minimum fuel injection amount Fmin. Through the determination performed in this manner, it is possible to determine a state that occurs immediately before the minimum fuel injection amount Fmin exceeds the planned demanded in-cylinder injection amount Fdio.

Since the minimum fuel injection amount Fmin used is the largest value among representative values or actually measured values of the same kind of in-cylinder-injecting fuel injection valves 6, there exists an error between the minimum fuel injection amount Fmin and the actual minimum fuel injection amount Fmin of the in-cylinder-injecting fuel injection valves 6 actually used in the internal combustion engine 2. Due to this error, there is possibility that even when the planned demanded in-cylinder injection amount Fdio is smaller than the actual minimum fuel injection amount, it may be still determined that Fdio≧Fmin, and therefore an amount of fuel larger than the planned demanded in-cylinder injection amount Fdio may be injected from the in-cylinder-injecting fuel injection valves 6.

In order to absorb this error, the state immediately before the minimum fuel injection amount Fmin approaches and exceeds the planned demanded in-cylinder injection amount Fdio is determined by determining whether or not Fdio≧Fmin×Kf, or whether or not Fdio≧Fmin+dF. Then, when Fdio<Fmin×Kf or Fdio≦Fmin+dF, steps S118 and S120 are executed as in the case where in Embodiment 1, a negative determination is made in step S112.

Due to this operation, the rich shift of the air/fuel ratio can be certainly restrained, and deterioration of emissions can be substantially prevented.

### Embodiment 3

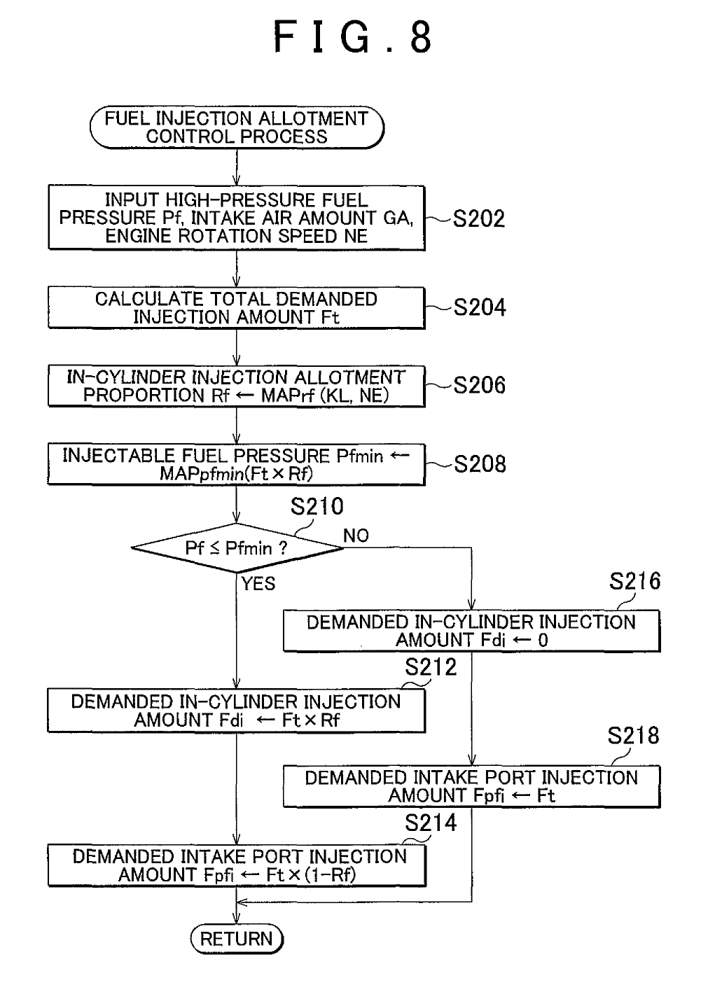

In this embodiment, a fuel injection allotment control process shown in FIG. 8 is executed in place of the fuel injection allotment control process (FIG. 4) of Embodiment 1, by an interrupt at every rotation of a constant crank angle. Other constructions are the same as in Embodiment 1.

When the fuel injection allotment control process (FIG. 8) starts, the high-pressure fuel pressure Pf, the intake gas amount GA and the engine rotation speed NE are firstly input (S202), and then calculation of the total demanded injection amount Ft (S204) and calculation of the in-cylinder injection allotment proportion Rf (S206) are executed. These steps S202 to S206 are the same processes as the steps S102, S106 and S108, respectively, in the fuel injection allotment control process (FIG. 4).

Next, on the basis of the “Ft×Rt” (g) that is the allotted fuel injection amount of the in-cylinder-injecting fuel injection valves 6, an injectable fuel pressure Pfmin (Pa) that is the highest fuel pressure at which the allotted fuel injection amount Ft×Rt can be injected is calculated using a map MAPpfmin that is inverse to the map MAPfmin shown in FIG. 5 (S208). That is, the minimum fuel pressure among fuel pressures at which the allotted fuel injection amount cannot be injected is found as an injectable fuel pressure Pfmin. Incidentally, it is also permissible that, using the map MAPfmin (FIG. 5), a value of the high-pressure fuel pressure Pf is found from the value of the minimum fuel injection amount Fmin that corresponds to “Ft×Rt”, and this value is set as an injectable fuel pressure Pfmin.

Next, it is determined whether or not the high-pressure fuel pressure Pf actually detected by the fuel pressure sensor 34 is less than or equal to the injectable fuel pressure Pfmin (S210). Herein, if the high-pressure fuel pressure Pf the injectable fuel pressure Pfmin (YES in S210), it is possible to actually inject the foregoing allotted fuel injection amount “Ft×Rt” from the in-cylinder-injecting fuel injection valves 6, and therefore the value “Ft×Rt” is immediately set as the demanded in-cylinder injection amount Fdi (S212).

Then, as shown in the foregoing expression 2, the demanded intake port injection amount Fpfi is calculated (S214). In this manner, the allotted injection amounts (Fdi, Fpfi) achieved by the injection from the in-cylinder-injecting fuel injection valves 6 and the injection from the intake port-injecting fuel injection valves 12 are determined. Then, the demanded intake port injection amount Fpfi of fuel is injected from the intake port-injecting fuel injection valves 12, and the demanded in-cylinder injection amount Fdi of fuel is injected from the in-cylinder-injecting fuel injection valves 6, at their respective timings described above in conjunction with the foregoing Embodiment 1.

Next, as described above in conjunction with Embodiment 1, in the case where the fuel-cut discontinues before the actual high-pressure fuel pressure Pf becomes sufficiently low, there is possibility of the high-pressure fuel pressure Pf becoming higher than the injectable fuel pressure Pfmin.

Therefore, in the case where high-pressure fuel pressure Pf>the injectable fuel pressure Pfmin (NO in S210), the demanded in-cylinder injection amount Fdi is set at 0 (S216), and the total demanded injection amount Ft is directly set as the demanded intake port injection amount Fpfi (S218). That is, a process of forcing the setting of the in-cylinder injection allotment proportion Rf=0 is performed.

As for the correspondence of foregoing constructions to elements or the like described in the appended claims, the steps S208 and S210 in the fuel injection allotment control process (FIG. 8) may be regarded as corresponding to a process as the excessive injection state determination means, and steps S216 and S218 may be regarded as corresponding to a process as the alternative injection means, and step S206 may be regarded as corresponding to a process as the fuel injection amount allotment setting means.

According to Embodiment 3 described above, the following effects will be achieved. (1) It can be determined that an excessive injection state is present in the in-cylinder-injecting fuel injection valves 6, also by comparing the high-pressure fuel pressure Pf that is actually measured and the injectable fuel pressure Pfmin. Therefore, the effect as stated above in conjunction with Embodiment 1 is obtained.

### Embodiment 4

It is determined whether or not Pf≦Pfmin in step S210 in the fuel injection allotment control process (FIG. 8) in Embodiment 3 whereas in Embodiment 4, it is instead determined whether or not Pf≦Pfmin·Kp, or whether or not Pf≦Pfmin−dP.

Incidentally, the coefficient Kp is a value as a decreasing coefficient that is less than 1; for example, the coefficient Kp is “0.9” or the like. The subtractive value dP represents a value for giving a decrease corresponding to a marginal amount to the injectable fuel pressure Pfmin. Through the determination performed in this manner, it is possible to determine a state that occurs immediately before the injectable fuel pressure Pfmin becomes less than the high-pressure fuel pressure Pf.

Since the injectable fuel pressure Pfmin is the smallest value of representative values or actually measured values of the same kind of in-cylinder-injecting fuel injection valves 6, there exists an error between the injectable fuel pressure Pfmin used and the actual injectable fuel pressure Pfmin of the in-cylinder-injecting fuel injection valves 6 actually used in the internal combustion engine 2. Due to this error, there is possibility that even when the actual high-pressure fuel pressure Pf exceeds the injectable fuel pressure Pfmin, it may be still determined that Pf≦Pfmin, and therefore an amount of fuel larger than Ft×Rt may be injected from the in-cylinder-injecting fuel injection valves 6.

In order to absorb this error, the state immediately before the high-pressure fuel pressure Pf approaches and exceeds the injectable fuel pressure Pfmin is determined by determining whether or not Pf≦Pfmin·Kp, or whether or not Pf≦Pfmin−dP. Then, when Pf≦Pfmin·Kp or Pf≦Pfmin−dP, steps S216 and S218 are executed as in the case where in Embodiment 3, a negative determination is made in step S210.

Due to this operation, the rich shift of the air/fuel ratio can be certainly restrained, and deterioration of emissions can be substantially prevented.

### Embodiment 5

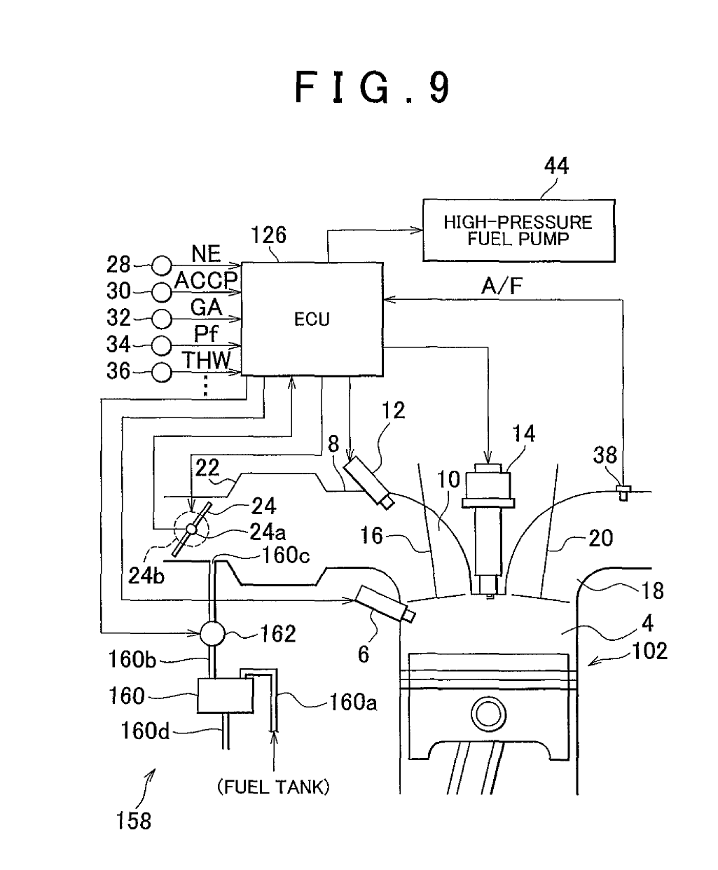

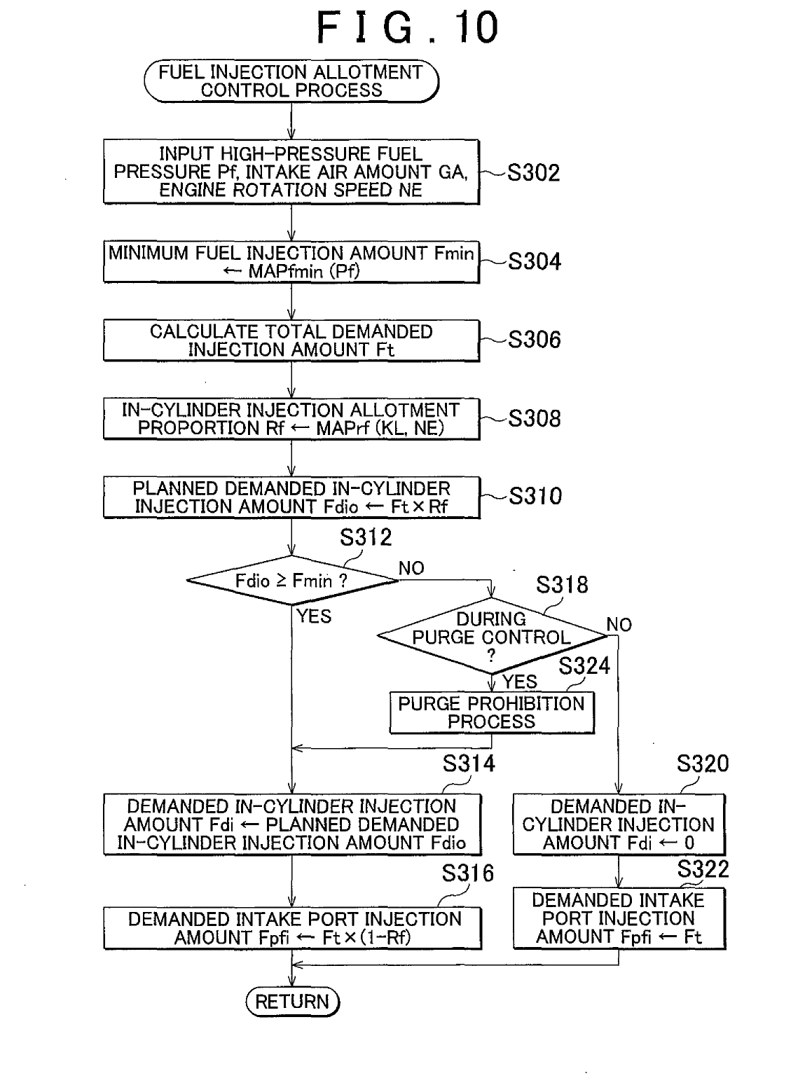

This embodiment, as shown in FIG. 9, is different from Embodiment 1 in that the internal combustion engine 102 is equipped with a purge mechanism 158 (corresponding to in-intake gas introduction means and purge means), and the purge rate is controlled by an ECU 126. Other constructions of Embodiment 5 are substantially the same as those of Embodiment 1 shown in FIGS. 1 and 2. Therefore, in FIG. 9, substantially the same constructions as those shown in FIG. 1 are denoted by the same reference characters.

The purge mechanism 158 is equipped with a canister 160 that is a trap container that traps fuel vapor that is produced in the fuel tank. This canister 160 is connected to the fuel tank via a vapor passageway 160a, and is also connected to a purge passageway 160b for supplying the trapped fuel vapor into an intake passageway 8 of an internal combustion engine 102. The purge passageway 160b is linked to a purge port 160c that is open to the intake passageway 8 downstream of a throttle valve 24. The canister 160 is filled with an adsorbent (e.g., active carbon) that adsorbs fuel vapor, and is provided with an atmospheric passageway 160d for introducing atmospheric air into the canister 160 via a check valve during execution of purge. The purge passageway 160b is provided with a purge control valve 162 that controls the purge rate. The purge control valve 162 is constructed so that the purge rate of the trapped fuel vapor can be adjusted by the ECU 126 adjusting the degree of opening of the purge control valve 162.

The ECU 126, before purging the fuel vapor into the intake gas via the purge control valve 162, executes a process of temporarily opening the purge control valve 162 and detecting a purge gas concentration from a change in the air/fuel ratio A/F that is detected by the air/fuel ratio sensor 38. Therefore, the foregoing total demanded injection amount Ft is set at an amount obtained by subtracting an amount of fuel that corresponds to the purge gas concentration from the actually demanded amount of fuel.

Hence, when the purge control is being executed, the fuel injection amount becomes accordingly lower, so that there is increased possibility of the fuel injection amount of the in-cylinder-injecting fuel injection valves 6 becoming smaller than the minimum fuel injection amount, and therefore the air/fuel ratio is likely to become rich.

Therefore, the ECU 126 executes a fuel injection allotment control process shown in FIG. 10 instead of the fuel injection allotment control process of Embodiment 1 (FIG. 4), by interrupt at every rotation of a constant crank angle. Other constructions of Embodiment 5 are substantially the same as those of Embodiment 1. In the fuel injection allotment control process (FIG. 10), steps S302 to S316, and steps S320 and S322 are the same processes as steps S102 to S120, respectively, in FIG. 4. The fuel injection allotment control process (FIG. 10) is different from that shown in FIG. 4 in that if the planned demanded in-cylinder injection amount Fdio<the minimum fuel injection amount Fmin (No in S312), it is determined in step S318 whether or not the purge control is being executed, and if the purge control is being executed (YES in S318), a purge prohibition process is performed in step S324, which is followed by steps S314 and S316.

Hence, when Fdio<Fmin (NO in S312), if the purge control is being executed (YES in S318), the release of fuel vapor into intake gas is prohibited by completely closing the purge control valve 162 (S324). Then, as in the case where Fdio≧Fmin, the fuel injection from the in-cylinder-injecting fuel injection valves 6 is allowed to be executed on the basis of the planned demanded in-cylinder injection amount Fdio (S314).

When the purge control is not being executed (NO in S318), the demanded in-cylinder injection amount Fdi is set at 0 (S320), and the total demanded injection amount Ft is directly set as the demanded intake port injection amount Fpfi (S322), as in Embodiment 1. That is, the in-cylinder injection allotment proportion Rf=0 is forced to be set. Hence, if the purge control is not being executed, the same process as in Embodiment 1 is performed.

As for the correspondence of foregoing constructions to elements or the like described in the appended claims, the ECU 126 may be regarded as corresponding to the excessive injection state determination means, the alternative injection means, the fuel injection amount allotment setting means, the in-cylinder injection fuel pressure adjustment means, and rich-shift restraint means. Furthermore, in the fuel injection allotment control process (FIG. 10), steps S304, S310 and S312 may be regarded as corresponding to a process as the excessive injection state determination means, and steps S320 and 5322 may be regarded as corresponding to a process as the alternative injection means, and step S308 may be regarded as corresponding to a process as the fuel injection amount allotment setting means, and steps S318 and S324 may be regarded as corresponding to a process as the rich-shift restraint means.

According to Embodiment 5 described above, the following effects will be achieved. (1) Besides the effects achieved by Embodiment 1, when it is determined that the excessive injection state comes about (NO in S312), the purging, if the purge control is being executed (YES in S318), is prohibited so as to adjust the air/fuel ratio to an increased ratio side. This restrains the rich shift of the air/fuel ratio even when the in-cylinder-injecting fuel injection valves 6 perform excessive injection.

Hence, the opportunities of executing the in-cylinder injection without cancelling demanded in-cylinder injection, so that a smooth control of the internal combustion engine becomes possible.

### Embodiment 6

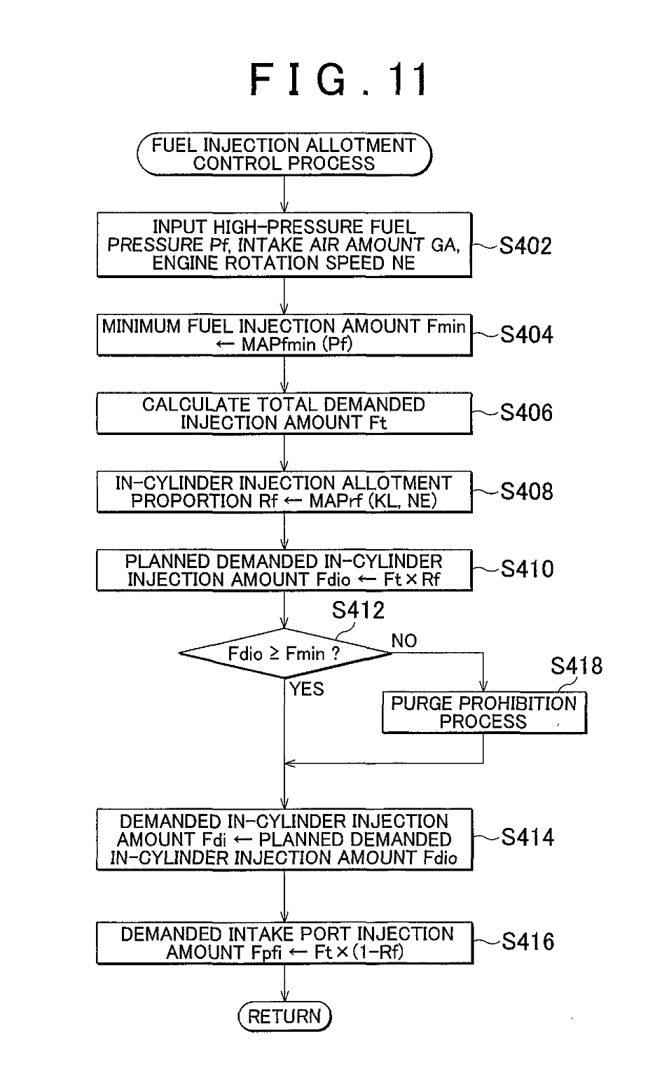

In this embodiment, a fuel injection allotment control process shown in FIG. 11 is executed instead of the fuel injection allotment control process of Embodiment 5 (FIG. 10), by interrupt at every rotation of a constant crank angle. Other constructions are substantially the same as those of Embodiment 5.

In the fuel injection allotment control process (FIG. 11), steps S402 to S416 are the same as steps S302 to S316, respectively, in FIG. 10. The fuel injection allotment control process of this embodiment is different in that if the planned demanded in-cylinder injection amount Fdio<the minimum fuel injection amount Fmin (NO in S412), a purge prohibition process is performed in step S418, which is followed by steps S414 and S416.

Hence, if Fdio<Fmin (NO in S412), the release of fuel vapor into intake gas is prohibited by completely closing the purge control valve 162 (S418) regardless of the open-closed state of the purge control valve 162 (FIG. 9). Then, as in the case where Fdio≧Fmin, the fuel injection from the in-cylinder-injecting fuel injection valves 6 is allowed to be performed on the basis of the planned demanded in-cylinder injection amount Fdio (S414).

As for the correspondence of foregoing constructions to elements or the like described in the appended claims, the ECU 126 may be regarded as corresponding to the excessive injection state determination means, the fuel injection amount allotment setting means, in-cylinder injection fuel pressure adjustment means, and the rich-shift restraint means. In the fuel injection allotment control process (FIG. 11), steps S404, S410 and 5412 may be regarded as corresponding to a process as the excessive injection state determination means, and step S408 may be regarded as corresponding to a process as the fuel injection amount allotment setting means, and step S418 may be regarded as corresponding to a process as the rich-shift restraint means.

According to Embodiment 6 described above, the following effects will be achieved. (1) If it is determined that the excessive injection state comes about (NO in S412), the purging is prohibited to adjust the air/fuel ratio to an increased ratio side (S418), so that even if the in-cylinder-injecting fuel injection valves 6 perform excessive injection, the rich shift of the air/fuel ratio can be restrained and therefore deterioration of emissions can be restrained.

### Embodiment 7

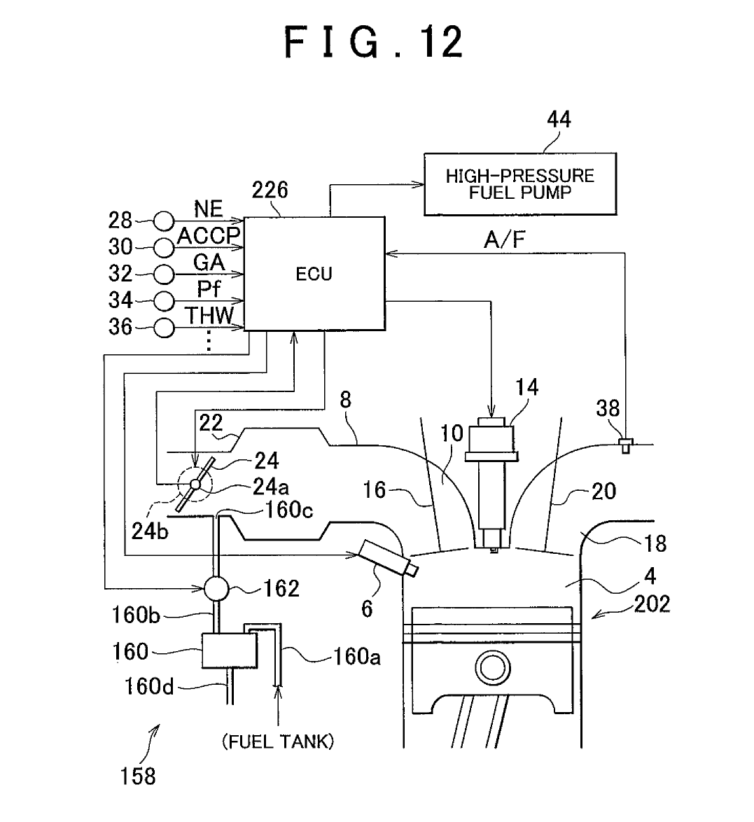

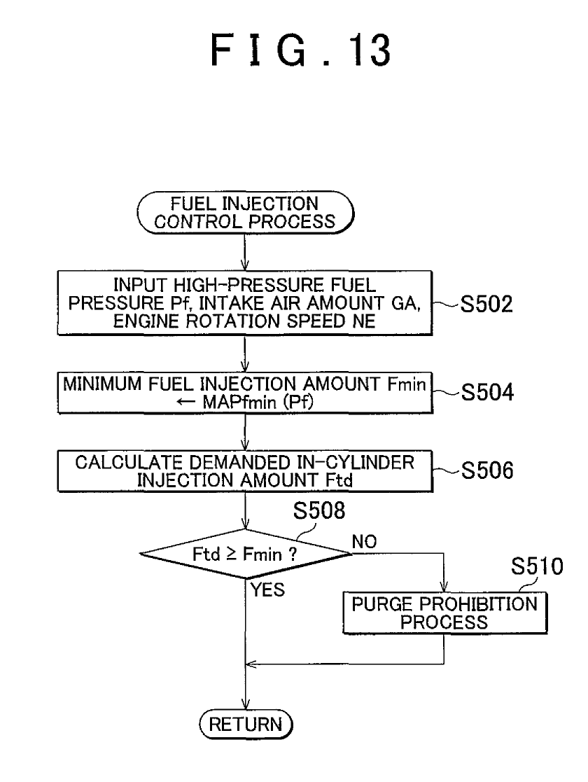

In this embodiment, using an internal combustion engine 202 and an ECU 226 shown in a block diagram in FIG. 12, a fuel injection control process shown in FIG. 13 is executed instead of the fuel injection allotment control process shown in FIG. 10, by interrupt at every rotation of a constant crank angle. The construction shown in FIG. 12 is different from the construction shown in FIG. 9, in that the intake port-injecting fuel injection valves 12 (FIG. 9) are not provided. That is, fuel is injected only by the in-cylinder injection from the in-cylinder-injecting fuel injection valves 6. Other constructions are substantially the same as those of Embodiment 5.

When the fuel injection control process (FIG. 13) starts, the high-pressure fuel pressure Pf, the intake gas amount GA and the engine rotation speed NE are input (S502) as in step S102 in FIG. 4, and a minimum fuel injection amount Fmin is calculated (S504) as in step S104.

Next, a demanded in-cylinder injection amount Ftd for the in-cylinder-injecting fuel injection valves 6 is calculated (S506) in substantially the same manner as in step S106, in which the total demanded injection amount Ft is calculated. Then, it is determined whether or not the demanded in-cylinder injection amount Ftd is greater than or equal to the minimum fuel injection amount Fmin found in step S504 (S508).

If it is determined that the demanded in-cylinder injection amount Ftd the minimum fuel injection amount Fmin (YES in S508), this process is immediately exited, so that the in-cylinder-injecting fuel injection valves 6 execute fuel injection of the demanded in-cylinder injection amount Ftd.

On the other hand, if the demanded in-cylinder injection amount Ftd<the minimum fuel injection amount Fmin (NO in S508), a purge prohibition process is executed (S510). This purge prohibition process is a process of the ECU 226 completely closing the purge control valve 162 regardless of the open-closed state of the purge control valve 162, whereby release of the fuel vapor from the canister 160 into the intake passageway 8 is entirely prevented.

Then, the process is exited, so that the in-cylinder-injecting fuel injection valves 6 execute the fuel injection of the demanded in-cylinder injection amount Ftd. As for the correspondence of foregoing constructions to elements or the like described in the appended claims, the ECU 226 may be regarded as corresponding to the excessive injection state determination means, the in-cylinder injection fuel pressure adjustment means, and the rich-shift restraint means. Furthermore, in the fuel injection control process (FIG. 13), steps S504, S506 and S508 may be regarded as corresponding to a process as the excessive injection state determination means, and step S510 may be regarded as corresponding to a process as the rich-shift restraint means.

According to Embodiment 7 described above, the effects of Embodiment 6 are achieved.

### Other Embodiments

### Although in Embodiments 5 to 7, the purge mechanism 158 is used as in-intake gas introduction means for introducing into the intake passageway a component that affects the air/fuel ratio, other in-intake gas introduction means may also be used. For example, in an internal combustion engine that adopts a construction in which blowby gas is released into the intake passageway, a blowby gas reduction device (also termed PCV, which corresponds to blowby gas reduction means) can be used as in-intake gas introduction means. A PCV valve provided for the blowby gas reduction device is controlled by an ECU so as to open or close in such a direction that the air/fuel ratio shifts to a lean side, during a state of excessive injection from in-cylinder-injecting fuel injection valves. In this manner, the rich shift of air/fuel ratio can be restrained.

Besides the PCV, an exhaust gas recirculation device (also termed EGR, which corresponds to exhaust gas recirculation means) may also be used as in-intake gas introduction means. That is, during the state of excessive injection from the in-cylinder-injecting fuel injection valves, the ECU closes the EGR valve, so that the recirculation of exhaust gas is restrained or stopped, resulting in an increased concentration of oxygen taken into the combustion chamber. In this manner, the air/fuel ratio shifts to the lean side, and thus the rich shift of air/fuel ratio can be restrained.

In Embodiment 3, the injectable fuel pressure Pfmin is set as a reference pressure, and if the high-pressure fuel pressure Pf>the injectable fuel pressure Pfmin, the injection by the in-cylinder-injecting fuel injection valves is prohibited. In Embodiments 5, 6 and 7, too, it is permissible to adopt a construction in which the presence/absence of the state of excessive injection may be determined through comparison between the high-pressure fuel pressure Pf and the injectable fuel pressure Pfmin instead of comparison between the demanded in-cylinder injection amount and the minimum fuel injection amount, and if the state of excessive injection is present (Pf>Pfmin), the process proceeds to the determination regarding execution of the purge control (S318) or to the purge prohibition control (S418, S510). In this case, too, the process may proceed to the determination regarding execution of the purge control (S318) or to the purge prohibition process (S418, S510), during a state that immediately precedes the state of excessive injection (Pf>Pfmin).

In Embodiments 5, 6 and 7, the process may proceed to the determination regarding execution of the purge control (S318) or to the purge prohibition control (S418, S510), during a state that immediately precedes the state of excessive injection (Fdio or Ftd<Fmin).

In Embodiments 5, 6 and 7, a process of lessening the purge rate may be performed instead of the purge prohibition process (S324, S418, S510). This also applies in the same manner in the cases where PCV or EGR is controlled.

While the invention has been described with reference to example embodiments thereof, it is to be understood that the invention is not limited to the described embodiments or constructions. To the contrary, the invention is intended to cover various modifications and equivalent arrangements. In addition, while the various elements of the example embodiments are shown in various combinations and configurations, other combinations and configurations, including more, less or only a single element, are also within the scope of the invention.

What is claimed is:

1. A control apparatus for an internal combustion engine that includes: an in-cylinder fuel injection portion that injects fuel into a combustion chamber of an internal combustion engine; and an in-intake passageway fuel injection portion that injects fuel into an intake passageway of the internal combustion engine, the control apparatus comprising:
an excessive injection state determination portion that determines whether or not an excessive injection state in which actual amount of fuel injection by the in-cylinder fuel injection portion is greater than a demanded in-cylinder fuel injection amount for the in-cylinder fuel injection portion occurs; and
an alternative injection portion that prohibits fuel injection performed by the in-cylinder fuel injection portion and executing the fuel injection of the demanded in-cylinder fuel injection amount by in-intake passageway fuel injection performed by the in-intake passageway fuel injection portion, if it is determined by the excessive injection state determination portion that the excessive injection state occurs.

2. The control apparatus for the internal combustion engine according to claim 1, wherein the excessive injection state determination portion handles as a kind of the excessive injection state a state in which a minimum fuel injection amount of the in-cylinder fuel injection portion is greater than the demanded in-cylinder fuel injection amount for the in-cylinder fuel injection portion, or a state that occurs immediately before the minimum fuel injection amount becomes greater than the demanded in-cylinder fuel injection amount.

3. The control apparatus for the internal combustion engine according to claim 1, wherein:
the excessive injection state determination portion sets a reference pressure that has possibility of causing the excessive injection state in the in-cylinder fuel injection portion; and
the excessive injection state determination portion handles as a kind of the excessive injection state a state in which fuel pressure supplied to the in-cylinder fuel injection portion is greater than the reference pressure, or a state that occurs immediately before the fuel pressure becomes greater than the reference pressure.

4. The control apparatus for the internal combustion engine according to claim 1, further comprising
a fuel injection amount allotment setting portion that sets allotments of fuel injection amount to the in-cylinder fuel injection portion and to the in-intake passageway fuel injection portion according to state of operation of the internal combustion engine,
wherein if it is determined by the excessive injection state determination portion that the excessive injection state occurs, the alternative injection portion causes the fuel injection amount allotment setting portion to set the fuel injection amount allotments so that no fuel injection amount is allotted to the in-cylinder fuel injection portion and entire fuel injection amount is accomplished by the in-intake passageway fuel injection portion.

5. The control apparatus for the internal combustion engine according to claim 1, further comprising an in-cylinder injection fuel pressure adjustment portion that adjusts fuel pressure supplied to the in-cylinder fuel injection portion according to state of operation of the internal combustion engine.

6. The control apparatus for the internal combustion engine according to claim 5, wherein the in-cylinder injection fuel pressure adjustment portion adjusts pressure of fuel supplied to the in-cylinder fuel injection portion according to the state of operation of the internal combustion engine by controlling driving of a fuel pressure boost mechanism that boosts pressure of fuel whose pressure has been brought to a fuel pressure that is used for injection performed by the in-intake passageway fuel injection portion, and that supplies pressure-boosted fuel to the in-cylinder fuel injection portion.

7. The control apparatus for the internal combustion engine according to claim 6, wherein the fuel pressure boost mechanism includes a pressure reduction portion that reduces the fuel pressure at in-cylinder fuel injection portion side when a pressure boosting process performed by the fuel pressure boost mechanism is stopped.

8. A control apparatus for the internal combustion engine that includes: an in-cylinder fuel injection portion that injects fuel into a combustion chamber of an internal combustion engine; and an in-intake gas introduction portion that introduces a component that affects air/fuel ratio into an intake passageway of the internal combustion engine, the control apparatus comprising:
an excessive injection state determination portion that determines whether or not an excessive injection state in which actual amount of fuel injection by the in-cylinder fuel injection portion is greater than a demanded in-cylinder fuel injection amount for the in-cylinder fuel injection portion occurs; and
a rich-shift restraint portion that adjusts amount of the component introduced by the in-intake gas introduction portion to such a side that the air/fuel ratio increases, if it is determined by the excessive injection state determination portion that the excessive injection state occurs.

9. The control apparatus for the internal combustion engine according to claim 8, wherein the in-intake gas introduction portion includes a purge portion that introduces fuel vapor from a canister into the intake passageway, and
wherein the rich-shift restraint portion executes adjustment to such a side as to increase the air/fuel ratio, by lessening amount of the fuel vapor introduced by the purge portion.

10. The control apparatus for the internal combustion engine according to claim 8, wherein the in-intake gas introduction portion includes a blowby gas reduction portion that introduces blowby gas into the intake passageway, and
wherein the rich-shift restraint portion executes adjustment to such a side as to increase the air/fuel ratio, by adjusting amount of the blowby gas introduced by the blowby gas reduction portion.

11. The control apparatus for the internal combustion engine according to claim 8, wherein:
the in-intake gas introduction portion includes exhaust gas recirculation portion that recirculates exhaust gas into the intake passageway; and
the rich-shift restraint portion executes adjustment to such a side as to increase the air/fuel ratio, by lessening amount of the exhaust gas recirculated by the exhaust gas recirculation portion.

12. The control apparatus for the internal combustion engine according to claim 8, wherein the internal combustion engine is provided with an in-intake passageway fuel injection portion that injects fuel into the intake passageway of the internal combustion engine.

13. The control apparatus for the internal combustion engine according to claim 12, further comprising a fuel injection amount allotment setting portion that sets allotments of fuel injection amount to the in-cylinder fuel injection portion and to the in-intake passageway fuel injection portion according to state of operation of the internal combustion engine.

14. The control apparatus for the internal combustion engine according to claim 8, further comprising an in-cylinder injection fuel pressure adjustment portion that adjusts fuel pressure supplied to the in-cylinder fuel injection portion according to state of operation of the internal combustion engine.

15. The control apparatus for the internal combustion engine according to claim 14, wherein the in-cylinder injection fuel pressure adjustment portion adjusts pressure of fuel supplied to the in-cylinder fuel injection portion according to the state of operation of the internal combustion engine by controlling driving of a fuel pressure boost mechanism that boosts pressure of fuel whose pressure has been brought to a fuel pressure that is used for injection performed by the in-intake passageway fuel injection portion, and that supplies pressure-boosted fuel to the in-cylinder fuel injection portion.

16. The control apparatus for the internal combustion engine according to claim 15, wherein the fuel pressure boost mechanism includes a pressure reduction portion that reduces the fuel pressure at an in-cylinder fuel injection portion side when a pressure boosting process performed by the fuel pressure boost mechanism is stopped.

17. A control method for an internal combustion engine that includes: an in-cylinder fuel injection portion that injects fuel into a combustion chamber of the internal combustion engine; and an in-intake passageway fuel injection portion that injects fuel into an intake passageway of the internal combustion engine, the control method comprising:
determining whether or not an excessive injection state in which actual amount of fuel injection by the in-cylinder fuel injection portion is greater than a demanded in-cylinder fuel injection amount for the in-cylinder fuel injection portion occurs; and
prohibiting fuel injection performed by the in-cylinder fuel injection portion and executing the fuel injection of the demanded in-cylinder fuel injection amount through in-intake passageway fuel injection performed by the in-intake passageway fuel injection portion, if it is determined that the excessive injection state occurs.

18. A control method for an internal combustion engine that includes: an in-cylinder fuel injection portion that injects fuel into a combustion chamber of the internal combustion engine; and an in-intake gas introduction portion that introduces a component that affects air/fuel ratio into an intake passageway of the internal combustion engine, the control method comprising:
determining whether or not an excessive injection state in which actual amount of fuel injection by the in-cylinder fuel injection portion is greater than a demanded in-cylinder fuel injection amount for the in-cylinder fuel injection portion occurs; and
adjusting amount of the component introduced by the in-intake gas introduction portion to such a side that the air/fuel ratio increases, if it is determined that the excessive injection state occurs.
